(19) United States
(12) Patent Application Publication
(10) Pub. No.: US 2013/0215982 A1
(43) Pub. Date: Aug. 22, 2013

(54) COMMUNICATION SYSTEM, COMMUNICATION METHOD, RELAYING DEVICE, AND RECORDING MEDIUM

(71) Applicants: Sumitomo Electric Networks Inc., (US); Sumitomo Electric Industries, Ltd., (US); Sumitomo Wiring Systems, Ltd., (US); Autonetworks Technologies, Ltd, (US)

(72) Inventors: Junichi SHIRASU, Osaka (JP); Takashi YANO, Osaka (JP); Kenichi HATANAKA, Osaka (JP)

(73) Assignees: SUMITOMO ELECTRIC NETWORKS, INC., Tokyo (JP); AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 13/772,134

(22) Filed: Feb. 20, 2013

(30) Foreign Application Priority Data
Feb. 20, 2012 (JP) 2012-034208

(51) Int. Cl. H04B 3/54

(52) U.S. Cl. CPC H04B 3/54
USPC 375/257

(57) ABSTRACT

A communication system between a vehicle and a communication device is disclosed. The vehicle transmits electricity supply information in an A-method to a relaying device like an electricity supply device through an electricity supply line. The electricity supply device receives the electricity supply information in the A-method, then, based on the electricity supply information in the A-method, generates electricity supply information in a B-method, and transmits to the communication device the electricity supply information obtained by conversion into the B-method. The communication device transmits electricity supply information in the B-method to the electricity supply device. The electricity supply device receives the electricity supply information in the B-method, then, based on the received electricity supply information in the B-method, generates electricity supply information in the A-method, and transmits the electricity supply information obtained by conversion into the A-method, to the vehicle through the electricity supply line.

### CROSS-REFERENCE TO RELATED APPLICATIONS

This Nonprovisional application claims priority under 35 U.S.C. §119(a) on Patent Application No. 2012-34208 filed in Japan on Feb. 20, 2012, the entire contents of which are hereby incorporated by reference.

### FIELD

The present invention relates to a communication system and a communication method employing a vehicle provided with an electricity storage part, a communication device performing communication of electricity supply information concerning electricity supply to the electricity storage part, and a relaying device relaying communication. It also relates to a relaying device employed in the communication system and a recording medium in which a computer program implementing the relaying device is recorded.

### BACKGROUND

In recent years, electric vehicles and hybrid cars begin to spread in which devices such as a motor and a battery are mounted and the motor is driven with electricity stored in the battery so that running is achieved. Such electric vehicles need electricity supply from an external electricity supply device to the battery. Further, hybrid cars include a plug-in hybrid car in which electricity supply from an external electricity supply device to the battery is allowed.

A system has been proposed in which such a vehicle, an electricity supply device, and a communication device that is managed by an electric power company and that records information concerning electricity supply are connected to each other in a manner permitting communication and then electricity supply information concerning electricity supply like a price plan is transmitted and received (for example, see Japanese Patent No. 4807329).

### SUMMARY

Nevertheless, such communication devices are managed by different electric power companies depending on the districts. Thus, it is expected that the methods such as application formats for electricity supply information adopted in the communication devices managed by the electric power companies vary depending on the districts. Here, in order that a vehicle should be allowed to perform communication with a communication device, an application (API) need be installed that corresponds to the method corresponding to information provided by the corresponding electric power company.

A moving body like a vehicle receives electricity supply not always from the same electric power company. Thus, in a district managed by a different electric power company, communication need be achieved with a communication device adopting electricity supply information in a different method. Nevertheless, in an already proposed system like that described in Japanese Patent No. 4807329, such a situation is not considered. Thus, in such an already proposed system, a problem may arise that when electricity supply information concerning electricity supply is to be transmitted to and received from a communication device, a method difference prohibits processing on the electricity supply information.

The present invention has been devised in view of this situation. Its object is to provide: a communication system and a communication method in which on the basis of electricity supply information in one method, a relaying device generates electricity supply information in another method so that communication between the communication device and a vehicle is achieved regardless of the method on the communication device side; a relaying device employed in the communication system; and a recording medium in which a computer program implementing the relaying device is recorded.

The communication system according to the present invention is a communication system comprising a relaying device relaying communication between a vehicle, the vehicle including an electricity storage part and with a communication part, and a communication device performing communication of electricity supply information concerning electricity supply to the electricity storage part, the relaying device including: means for performing communication of electricity supply information to and from the vehicle by a first method; means for performing communication of electricity supply information to and from the communication device by a second method different from the first method; and means for, on the basis of the electricity supply information received by any one of the first method and the second method, generating electricity supply information to be transmitted by the other method.

In the communication system according to the present invention, the vehicle and the relaying device are allowed to be connected through an electricity supply line used for electricity supply, and the communication of electricity supply information by the first method is communication through the electricity supply line.

In the communication system according to the present invention, the communication device includes: means for performing authentication of the relaying device; and means for transmitting condition information that indicates a plurality of conditions concerning electricity supply, to the relaying device whose authentication has been succeeded, and the relaying device further includes means for transmitting, to the communication device, selection information that indicates one condition selected from the plurality of conditions indicated in the received condition information.

The communication method according to the present invention is a communication method employing a relaying device relaying communication between a vehicle provided with an electricity storage part and with a communication part and a communication device performing communication of electricity supply information concerning electricity supply to the electricity storage part, the relaying device receives electricity supply information transmitted from any one of the vehicle and the communication device by a first method, then, on the basis of the received electricity supply information, generates electricity supply information to be transmitted by a second method different from the first method, and then transmits the electricity supply information to the other one by the second method.

The relaying device according to the present invention is a relaying device relaying communication between a vehicle provided with an electricity storage part and with a communication part and a communication device performing communication of electricity supply information concerning electricity supply to the electricity storage part, comprising: first communication means for performing communication of electricity supply information to and from the vehicle by a first method; second communication means for performing communication of electricity supply information to and from the communication device by a second method different from the first method; and means for, on the basis of the electricity supply information received by any one of the first method and the second method, generating electricity supply information to be transmitted by the other method.

The relaying device according to the present invention further comprises means for supplying electricity through an electricity supply line connectable to the vehicle, wherein the first communication means performs communication of electricity supply information through the electricity supply line by the first method.

In the relaying device according to the present invention, connection to an electricity supply device is achievable, the electricity supply device being connectable to the vehicle through an electricity supply line used for electricity supply and performing communication of electricity supply information to and from the vehicle through the electricity supply line, and the first communication means performs communication with the vehicle through the electricity supply device.

The relaying device according to the present invention further comprises means for measuring the amount of electricity concerning electricity supply and means for transmitting to the communication device the measured amount of electricity.

The relaying program according to the present invention is a relaying program causing a computer relaying communication between a vehicle provided with an electricity storage part and a communication device performing communication of electricity supply information concerning electricity supply to the electricity storage part to execute a procedure concerning relaying, wherein the relaying program causes the computer to execute: a step of, when electricity supply information transmitted from any one of the vehicle and the communication device by a first method is received, on the basis of the received electricity supply information, generating electricity supply information to be transmitted by a second method different from the first method; and a step of transmitting the generated electricity supply information to the other one by the second method.

The present invention realizes communication between a vehicle and a communication device that adopt electricity supply information in mutually different methods.

The communication system, the communication method, the relaying device, and the recording medium according to the present invention permit communication between a vehicle and a communication device that adopt mutually different methods concerning electricity supply information. Thus, an excellent effect is obtained that, for example, even when a vehicle moves and goes into a situation that communication with a communication device adopting electricity supply information in a different method is necessary, communication becomes achievable between the communication device and the vehicle.

The above and further objects and features of the invention will more fully be apparent from the following detailed description with accompanying drawings.

### BRIEF DESCRIPTION OF THE DRAWINGS

FIG. 1 is an explanation diagram conceptually illustrating an exemplary configuration of a communication system according to Embodiment 1 of the present invention.

FIG. 2 is a block diagram illustrating an exemplary configuration of hardware of individual devices employed in the communication system according to Embodiment 1 of the present invention.

FIG. 3 is an explanation diagram conceptually illustrating an example of electricity supply information employed in the communication system according to Embodiment 1 of the present invention.

FIG. 4 is a block diagram illustrating an exemplary configuration of functions concerning communication processing of individual devices employed in the communication system according to Embodiment 1 of the present invention.

FIG. 5 is a flow chart illustrating an example of initial processing in an electricity supply device according to Embodiment 1 of the present invention.

FIG. 6 is a sequence diagram illustrating an example of authentication processing in the electricity supply device and a communication device according to Embodiment 1 of the present invention.

FIG. 7 is a sequence diagram illustrating an example of communication processing in a vehicle, the electricity supply device, and the communication device according to Embodiment 1 of the present invention.

FIG. 8 is a block diagram illustrating an exemplary configuration of hardware of individual devices employed in a communication system according to Embodiment 2 of the present invention.

FIG. 9 is a block diagram illustrating an exemplary configuration of functions concerning communication processing of individual devices employed in the communication system according to Embodiment 2 of the present invention.

FIG. 10 is a block diagram illustrating an exemplary configuration of hardware of individual devices employed in a communication system according to Embodiment 3 of the present invention.

FIG. 11 is a block diagram illustrating an exemplary configuration of functions concerning communication processing of individual devices employed in the communication system according to Embodiment 3 of the present invention.

FIG. 12 is an explanation diagram conceptually illustrating an exemplary configuration of a communication system according to Embodiment 4 of the present invention.

FIG. 13 is a block diagram illustrating an exemplary configuration of hardware of individual devices employed in the communication system according to Embodiment 4 of the present invention.

FIG. 14 is a block diagram illustrating an exemplary configuration of functions concerning communication processing of individual devices employed in the communication system according to Embodiment 4 of the present invention.

FIG. 15 is a block diagram illustrating an exemplary configuration of hardware of individual devices employed in a communication system according to Embodiment 5 of the present invention.

FIG. 16 is a block diagram illustrating an exemplary configuration of functions concerning communication processing of individual devices employed in the communication system according to Embodiment 5 of the present invention.

FIG. 17 is a block diagram illustrating an exemplary configuration of hardware of individual devices employed in a communication system according to Embodiment 6 of the present invention.

FIG. 18 is a block diagram illustrating an exemplary configuration of functions concerning communication processing of individual devices employed in the communication system according to Embodiment 6 of the present invention.

### DETAILED DESCRIPTION

The present invention is described below in detail with reference to the drawings illustrating embodiments.

### Embodiment 1

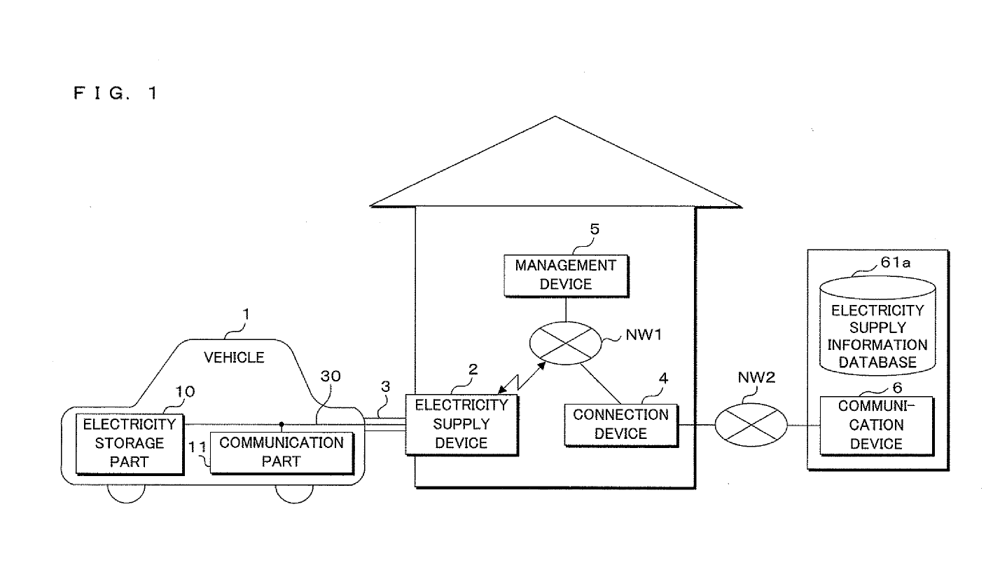

FIG. 1 is an explanation diagram conceptually illustrating an exemplary configuration of a communication system according to Embodiment 1 of the present invention. Numeral 1 in FIG. 1 indicates a vehicle such as an electric vehicle and a plug-in hybrid car. The vehicle 1 includes an electricity storage part 10 and a communication part 11.

The vehicle 1 is allowed to be connected through a charging cable 3 to an electricity supply device 2 installed in a building such as a residential house and an office building. The charging cable 3 contains various kinds of wiring like a pair of electricity supply line 30 wires serving as a power supply line. The vehicle 1 receives electricity supply performed through the electricity supply line 30 to the electricity storage part 10. Further, communication is achieved by the communication part 11 through the electricity supply line 30.

The electricity supply line 30 contained in the charging cable 3 connecting the electricity supply device 2 to the vehicle 1 is an AC line on which an alternating voltage is applied. Then, electricity supply is achieved from the electricity supply device 2 through the electricity supply line 30 to the electricity storage part 10 provided in the vehicle 1. Further, the electricity supply line 30 is connected also to the communication part 11 through internal wiring in the vehicle 1. Then, the communication part 11 performs PLC (Power Line Communication) communication in which various kinds of information such as electricity supply information concerning electricity supply is transmitted to and received from the electricity supply device 2 through the electricity supply line 30.

The electricity supply device 2 is installed in the building and connected in a manner permitting communication to a connection device 4 such as a gateway device connecting different communication networks, so that an internal communication network NW1 is formed like a home network and an office LAN (Local Area Network). The electricity supply device 2 and the connection device 4 are connected to each other in a manner permitting communication according to a communication method of wireless LAN standard or the like. Here, the connection may be achieved according to a communication method of cable LAN standard and the like.

The internal communication network NW1 constructed in the building is connected to a management device 5 such as a HEMS adaptor that is connected to an energy management system such as a HEMS (Home Energy Management System) and a BEMS (Building and Energy Management System) so as to manage energy used in the building.

The connection device 4 is connected to an external communication network NW2 such as the Internet and allowed to perform communication, through the external communication network NW2, with a communication device 6 such as a server computer managed by a business entity such as an electric power company. Information exchanged in the communication is, for example, electricity supply information recorded in an electricity supply information database 61a described later.

The vehicle 1 and the communication device 6 transmit and receive electricity supply information concerning electricity supply like electricity prices depending on the time zone. Transmission and reception of the electricity supply information is in accordance with a communication standard of SEP2.0 (Smart Energy Profile 2) or the like and performed by using a description language such as XML (eXtensible Markup Language) in accordance with a protocol such as HTTP (HyperText Transfer Protocol). Here, in the communication between the vehicle 1 and the communication device 6, the electricity supply device 2, the connection device 4, and the management device 5 serve as devices relaying transmission and reception of electricity supply information. Embodiment 1 is described below for a mode that the electricity supply device 2 serves as a relaying device of the present invention that executes processing concerning the communication method of the present invention at the time of relaying of transmission and reception of electricity supply information.

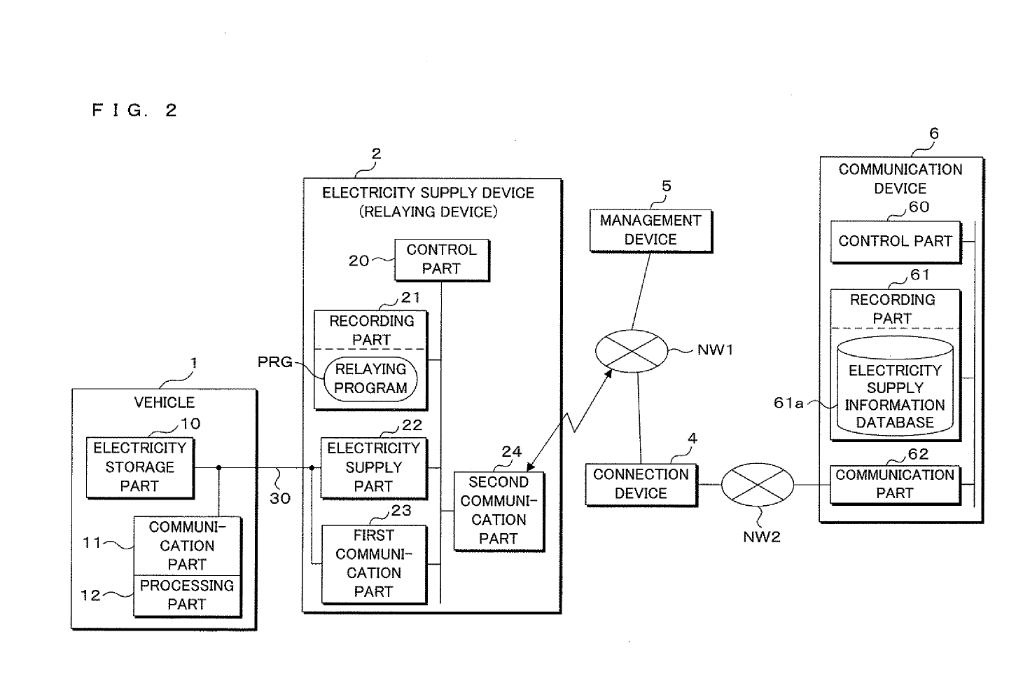

FIG. 2 is a block diagram illustrating an exemplary configuration of hardware of individual devices employed in the communication system according to Embodiment 1 of the present invention. The vehicle 1 has various kinds of parts including the electricity storage part 10, the communication part 11, and a processing part 12.

The electricity storage part 10 is constructed from a battery employing a secondary battery and is charged with electricity supplied through the electricity supply line 30. The communication part 11 transmits and receives various kinds of information such as electricity supply information through the electricity supply line 30. The processing part 12 is constructed from a processor executing processing on various kinds of information such as electricity supply information transmitted and received through the communication part 11. In the processing part 12, an application program executing processing on various kinds of information is incorporated.

The electricity supply device 2 has various kinds of parts including a control part 20, a recording part 21, an electricity supply part 22, a first communication part 23, and a second communication part 24. The control part 20 is constructed from a processor controlling the entire device. The recording part 21 is constructed from non-volatile and volatile memories recording information like various kinds of programs and data used for control. The electricity supply part 22 supplies electricity supplied from the electric power company, to the vehicle 1 through the electricity supply line 30. The first communication part 23 transmits and receives various kinds of information such as electricity supply information to and from the vehicle 1 through the electricity supply line 30. The second communication part 24 achieves connection to the internal communication network NW1 by a communication method of wireless LAN or the like.

Here, the recording part 21 contains a relaying program PRG of the present invention. Then, when the control part 20 executes various kinds of procedures set forth in the relaying program PRG, the electricity supply device 2 serves as a relaying device of the present invention.

The communication device 6 is constructed from a server computer such as a database server and has various kinds of parts including a control part 60, a recording part 61, and a communication part 62. The control part 60 is a processor such as a CPU controlling the entire device, and executes processing on various kinds of information recorded in the recording part 61 composed of a hard disk, a RAM, or the like. The communication part 62 is constructed from connectors and an attached program used for connection to the external communication network NW2 so as to achieve communication.

Here, a part of the recording area of the recording part 61 is used as an electricity supply information database 61a containing plural pieces of electricity supply information concerning electricity supply like electricity prices depending on the time zone.

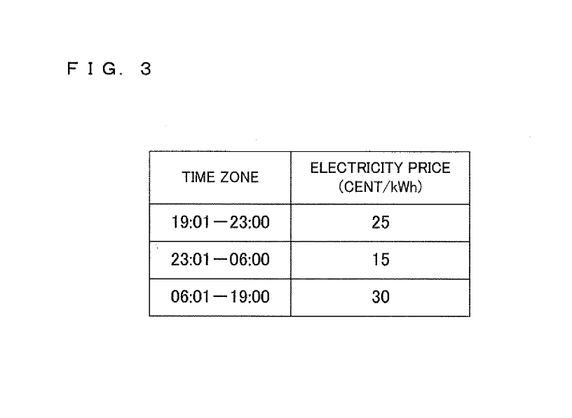

FIG. 3 is an explanation diagram conceptually illustrating an example of electricity supply information employed in the communication system according to Embodiment 1 of the present invention. The electricity supply information illustrated in FIG. 3 describes electricity prices depending on the time zone and is referred to as a tariff table. In the tariff table illustrated in FIG. 3, electricity prices are recorded in correspondence to time zones. The method of describing the electricity supply information illustrated in FIG. 3 is an example. That is, electricity supply information in various kinds of methods may be adopted like a method that the price is in correspondence to the values of elapsed time measured from the present time. Further, plural kinds of electricity supply information such as tariff tables are recorded in correspondence to the kinds of contracts. This is because, for example, a different price system is adopted for each kind of contract like a corporate contract, a personal contract, and other special contracts. Here, the electricity supply information is not limited to such information like a tariff table concerning the price in association with electricity supply as illustrated in the present embodiment. That is, the electricity supply information may include various kinds of information useful for determining the items concerning electricity supply like the time of day, a supply source, and the amount of electricity supply. For example, the information concerning electricity supply may include: information concerning electricity demand in the business entity serving as an electric power supply source; information concerning supply capability; and other information like various kinds of notices provided from the business entity. Detailed examples of such information include: information indicating electricity usage prediction; information indicating prediction of an electricity shortage time zone; information indicating the time of day of charging recommendation; and information indicating the maximum power available for charging for each time zone. Further, the information transmission source is not limited to a business entity such as an electric power company and may be another business entity such as a trading company or a supply destination such as a general consumer. Further, the electricity supply information includes information that indicates an abnormality having occurred during electricity supply and that is to be transmitted from the vehicle 1 side.

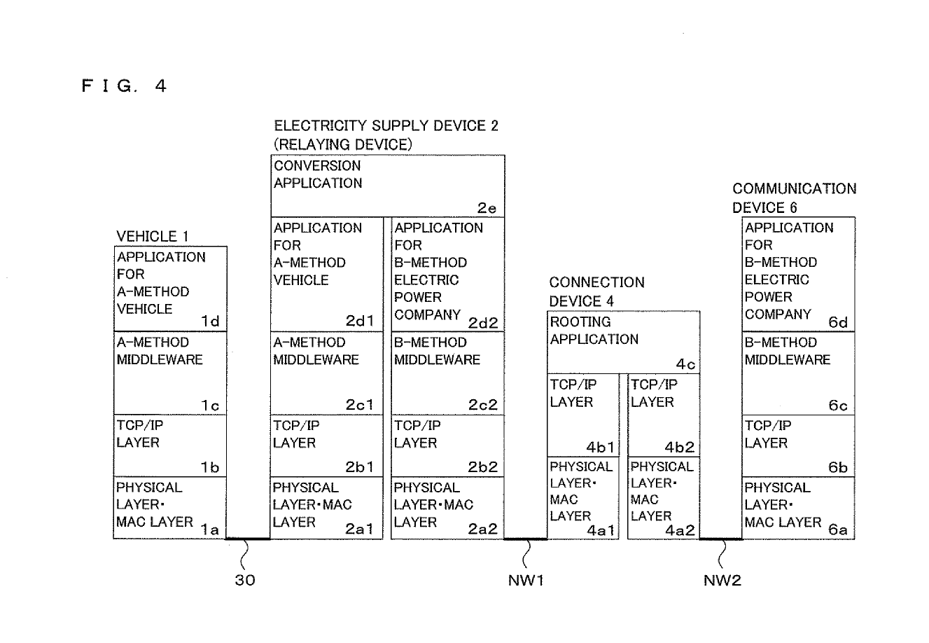

FIG. 4 is a block diagram illustrating an exemplary configuration of functions concerning communication processing of individual devices employed in the communication system according to Embodiment 1 of the present invention. The vehicle 1 has various kinds of functions hierarchically defined as functions concerning communication performed by individual parts like the communication part 11 and the processing part 12. That is, the vehicle 1 has a hierarchy concerning a physical interface set forth as a physical layer•MAC layer 1a, a hierarchy concerning a protocol set forth as a TCP/IP layer 1b, a hierarchy concerning middleware and a hierarchy concerning an application program. The hierarchy concerning middleware links a lower level hierarchy performing processing concerning communication to an upper level hierarchy performing processing on information, and is composed of middleware according to a standard of Smart Energy Profile 2.0, Echonet Lite, or the like. In the example of FIG. 4, A-method middleware 1c is incorporated as middleware for the vehicle 1. The hierarchy concerning an application program sets forth an application program executing processing on various kinds of information such as electricity supply information. In the example of FIG. 4, an application for A-method vehicle 1d is incorporated as an application program for the vehicle 1.

The communication device 6 has various kinds of functions hierarchically defined as functions concerning communication performed by individual parts like the control part 60 and the communication part 62. That is, the communication device 6 has a hierarchy concerning a physical interface set forth as a physical layer•MAC layer 6a, a hierarchy concerning a protocol set forth as a TCP/IP layer 6b, a hierarchy concerning middleware and a hierarchy concerning an application program. In the example of FIG. 4, B-method middleware 6c is incorporated as middleware for the communication device 6. Further, in the example of FIG. 4, an application for B-method electric power company 6d is incorporated as an application program for the communication device 6.

In the example illustrated in FIG. 4, the application method employed in the application for A-method vehicle 1d, that is, the A-method, is different from the application method employed in the application for B-method electric power company 6d, that is, the B-method. Thus, mutually different methods are employed in various kinds of information such as electricity supply information processed by the respective applications. Accordingly, electricity supply information corresponding to the application method employed in the application for A-method vehicle 1d is not appropriately processed by the application for B-method electric power company 6d. Further, electricity supply information corresponding to the application method employed in the application for B-method electric power company 6d is not appropriately processed by the application for A-method vehicle 1d.

As the functions of parts like the control part 20, the first communication part 23, and the second communication part 24, the electricity supply device 2 has the function of communication with the vehicle 1 and the function of communication with the connection device 4. That is, for the purpose of communication with the vehicle 1, the electricity supply device 2 has a physical layer•MAC layer 2a1, a TCP/IP layer 2b1, a hierarchy concerning middleware and a hierarchy concerning an application program. In the example of FIG. 4, A-method middleware 2c1 is incorporated as middleware, and an application for A-method vehicle 2d1 is incorporated as an application program. Then, the physical layer•MAC layer 1a of the vehicle 1 and the physical layer•MAC layer 2a1 of the electricity supply device 2 are set forth according to a method concerning communication like Home Plug Green PHY, and hence perform PLC communication according to the set-forth method through the electricity supply line 30.

Further, for the purpose of communication with the communication device 6 through the connection device 4, the electricity supply device 2 has a physical layer•MAC layer 2a2, a TCP/IP layer 2b2, a hierarchy concerning middleware, and a hierarchy concerning an application program. In the example of FIG. 4, B-method middleware 2c2 is incorporated as middleware, and an application for B-method electric power company 2d2 is incorporated as an application program.

Further, in the electricity supply device 2, a conversion application 2e is incorporated that serves as an application program converting the communication format between the A-method concerning communication with the vehicle 1 and the B-method concerning communication with the communication device 6.

The connection device 4 has the function of communication with the electricity supply device 2 and the function of communication with the communication device 6. That is, for the purpose of communication with the electricity supply device 2, the connection device 4 has a physical layer•MAC layer 4a1 and a TCP/IP layer 4b1. Then, the physical layer•MAC layer 2a2 of the electricity supply device 2 and the physical layer•MAC layer 4a1 of the connection device 4 are set forth according to a method concerning wireless LAN communication such as IEEE802.11 method, and hence perform wireless LAN communication according to the set-forth method.

Further, for the purpose of communication with the communication device 6, the connection device 4 has a physical layer•MAC layer 4a2 and a TCP/IP layer 4b2. Then, the connection device 4 and the communication device 6 execute communication with each other through the external communication network NW2.

Further, in the connection device 4, a routing application 4c determining a route for information to be transmitted and received is incorporated.

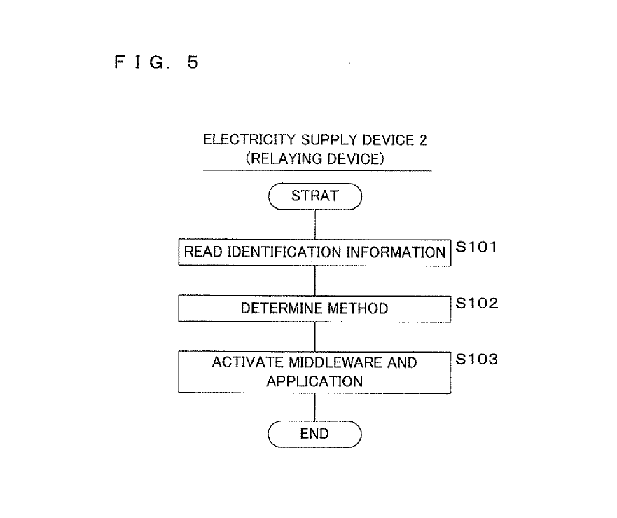

Next, description is given for an example of processing in the communication system according to Embodiment 1 of the present invention. FIG. 5 is a flow chart illustrating an example of initial processing in the electricity supply device 2 according to Embodiment 1 of the present invention. When it has been detected that the vehicle 1 is connected through the charging cable 3, under the control of the control part 20, the electricity supply device 2 executes the relaying program PRG so as to perform initial processing for establishing a state that the processing based on the functions illustrated in FIG. 4 is allowed to be performed. The initial processing is performed for the purpose that in a case that a plurality of vehicles 1 are allowed to be connected to the electricity supply device 2 and that any vehicle 1 performs communication by a different method, correspondence to the individual methods of the plurality of vehicles 1 should be ensured.

The control part 20 of the electricity supply device 2 reads, from the vehicle 1, identification information recorded in advance in the vehicle 1 (S101). The identification information read at step S101 may be identification information such as a global IP address and a MAC address imparted to each vehicle 1, as well as information identifying a vehicle type, information indicating a main usage district, and information indicating a communication method.

The control part 20 determines the method of middleware and application in correspondence to the method employed in the read identification information (S102). The recording part 21 of the electricity supply device 2 serving as a relaying device stores, in advance in a table format, data indicating a method corresponding to each identification information. At step S102, by referring to the table in which correspondence between identification information and a method is described, the electricity supply device 2 determines a method corresponding to the identification information read from the vehicle 1.

The control part 20 activates the middleware and the application corresponding to the determined method (S103). At this step S103, information containing a middleware and an application corresponding to a method, for example, the A-method, corresponding to the identification information read from the vehicle 1 is read from the recording part 21 and then the middleware and the application having been read are activated. Further, when necessary, communication destination information such as a URL (Universal Resource Locator) specifying a communication device 6 to be recognized as a communication counterpart to the vehicle 1 is notified to the vehicle 1 so that the vehicle 1 recognizes the communication device 6 as a communication counterpart. Here, in particular situations like a situation that the method concerning communication of the vehicle 1 connected to the electricity supply device 2 is fixed and a situation that electricity supply is to be performed on a vehicle 1 having been known to be corresponding to an initially setup method having been set up in advance in the electricity supply device 2, the initial processing may be omitted or simplified. An example of such situations is that a relaying device installed in the Western district is to relay electricity supply from a business entity operating within the Western district the to the vehicle 1 traveling mainly within the Western district. In this case, the method concerning the vehicle 1 is set equal to that of the business entity operating within the Western district. Then, in the relaying device, that method is adopted as the initial setting. In this example, when the relaying device identifies that the vehicle 1 serving as an electricity supply destination travels mainly within the Western district, the initial processing may be omitted. As such, the initial processing is executed.

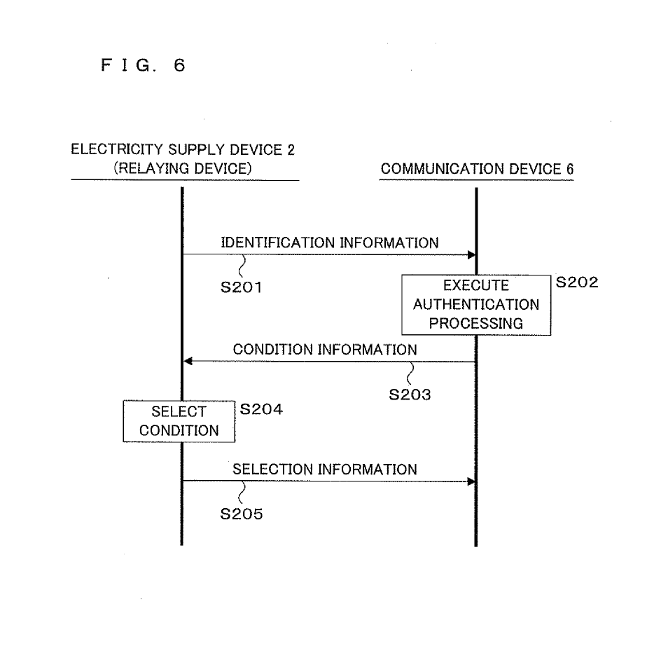

FIG. 6 is a sequence diagram illustrating an example of authentication processing in the electricity supply device 2 and the communication device 6 according to Embodiment 1 of the present invention. In the authentication processing, the electricity supply device 2 undergoes authentication performed by the communication device 6. The authentication processing is started at an occasion that the electricity supply device 2 executes the initial processing, that the electricity supply device 2 is activated, that a predetermined time of day has been reached, or that an implementation condition such as a predetermined time interval set up in advance is satisfied. When the control part 20 of the electricity supply device 2 executes the relaying program PRG, the control part 20 serves as a relaying device of the present invention and executes authentication processing. The control part 20 transmits identification information identifying the own device through the second communication part 24 to the communication device 6 set up in advance as a communication destination (S201). The present embodiment is described for a case that, for example, communication destination information such as a URL specifying the communication device 6 is set up in advance as information specifying a communication device 6. Further, in addition to an ID identifying the electricity supply device 2, the identification information contains information used for transmitting various kinds of information from the communication device 6 to the electricity supply device 2. Here, the method by which the vehicle 1 acquires communication destination information of the communication device 6 like a global IP address may be of various kinds like mDNS (multicast DNS) in which individual devices mutually perform request and response by multicast.

The control part 60 of the communication device 6 receives identification information through the communication part 62, then compares the received identification information with plural pieces of identification information recorded in advance in the recording part 61, and then executes the authentication processing (S202). When the received identification information agrees with any identification information recorded in advance, authentication is succeeded. In case of disagreement, authentication is failed.

The control part 60 transmits condition information that indicates a plurality of conditions concerning electricity supply, through the communication part 62 to the electricity supply device 2 whose authentication has been succeeded (S203). The condition concerning electricity supply transmitted at step S203 is information that indicates a plurality of tariff tables serving as candidates of application among a plurality of tariff tables recorded as electricity supply information.

The control part 20 of the electricity supply device 2 receives the condition information through the second communication part 24, and then selects one from the plurality of conditions indicated in the received condition information (S204). At this step S204, on the basis of the contents of contract recorded in advance, one condition (one tariff table) is selected from the plurality of tariff tables indicated in the condition information.

The control part 20 transmits selection information that indicates one condition selected from the plurality of conditions, through the second communication part 24 to the communication part 6 (S205). The selection information transmitted at step S205 may, in addition to the information indicating the condition, include information used for communication with the vehicle 1 connected through the charging cable 3 like identification information such as a global IP address imparted to the vehicle 1.

The control part 60 of the communication device 6 receives the selection information through the communication part 62 and then terminates the authentication processing.

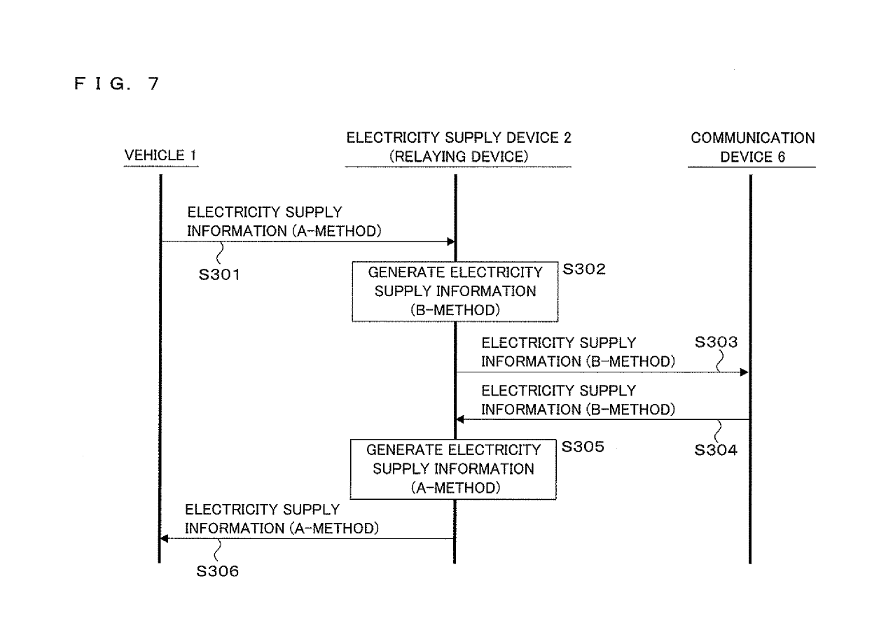

FIG. 7 is a sequence diagram illustrating an example of communication processing in the vehicle 1, the electricity supply device 2, and the communication device 6 according to Embodiment 1 of the present invention. After the termination of the authentication processing, communications processing using the electricity supply device 2 as a relaying device is executed between the vehicle 1 and the communication device 6. The information transmitted and received in the communications processing is the electricity supply information concerning electricity supply and the like and includes, for example, information indicating a tariff table and information requesting transmission of a tariff table. Here, an example is described that a transmission request for and transmission of a tariff table corresponding to one condition indicated in the selection information received by the communication device 6 as a result of authentication processing are processed as transmission and reception of electricity supply information.

The vehicle 1 transmits electricity supply information through the processing part 12 and the communication part 11 to the communication device 6 (S301). Here, an example is described that the electricity supply information at step S301 is request information requesting transmission of a tariff table. The electricity supply information to be transmitted is information generated in a format corresponding to the application of A-method illustrated in FIG. 4. Here, the request information may be in a common format independent of the method. The transmission is performed in a situation that the communication device 6 is assigned as a transmission destination. Nevertheless, since direct communication is not achievable between the vehicle 1 and the communication device 6, transmission is first directed through the electricity supply line 30 to the electricity supply device 2 serving as a relaying device. Here, when communication destination information such as a URL indicating the communication device 6 has been acquired in the above-mentioned initial processing, the vehicle 1 specifies the acquired communication destination information as a communication destination and then transmits the electricity supply information. When communication destination information has not been acquired, the electricity supply device 2 serving as a relaying device specifies the communication device 6 as a communication destination.

When the control part 20 of the electricity supply device 2 executes the relaying program PRG of the present invention, the control part 20 serves as a relaying device of the present invention and executes communication processing. The control part 20 receives electricity supply information in the A-method through the first communication part 23 and then, on the basis of the received electricity supply information in the A-method, generates electricity supply information in the B-method (S302). In the present embodiment, generation of electricity supply information at step S302 indicates conversion from the A-method to the B-method achieved when the control part 20 executes the conversion application 2e. Here, in place of the conversion of the format of the electricity supply information, conversion of the protocol or the like may be performed. Further, the processing performed here may be that additional information such as an identifier is added to the electricity supply information in the A-method, or alternatively that additional information is removed. That is, in the description given here, various kinds of processing that correspondence of the electricity supply information in the A-method to the B-method is established may be recognized as generation of electricity supply information in the B-method. Here, as described above, at step S302, request information is illustrated as the electricity supply information. Thus, when a common format is employed, conversion processing at step S303 is unnecessary.

The control part 20 transmits the electricity supply information obtained by conversion into the B-method, through the second communication part 24 to the communication device 6 via the internal communication network NW1 (S303). Here, when the communication destination information specifying the communication device 6 is not notified to the vehicle 1, at the time of transmission of the electricity supply information, the control part 20 sets up the communication destination information of the communication device 6 as a transmission destination.

The electricity supply information transmitted through the internal communication network NW1 is received by a connection device 4 (not illustrated) and then transferred from the connection device 4 through the external communication network NW2 to the communication device 6.

The control part 60 of the communication device 6 receives the electricity supply information through the communication part 62, and then transmits the tariff table requested in the received electricity supply information, as electricity supply information through the communication part 62 to the vehicle 1 via the external communication network NW2 (S304). The tariff table transmitted as the electricity supply information at step S304 is a tariff table selected in the selection information received in the authentication processing. Further, the tariff table transmitted as the electricity supply information is generated in a format corresponding to the application of B-method illustrated in FIG. 4. Transmission of the electricity supply information is performed in response to a request. At the time, for example, transmission may be performed on the basis of identification information such as the global IP address of the vehicle 1 added in the selection information.

The electricity supply information transmitted through the external communication network NW2 is received by the connection device 4 and then transferred from the connection device 4 through the internal communication network NW1 to the electricity supply device 2.

The control part 20 of the electricity supply device 2 receives the electricity supply information in the B-method through the second communication part 24 and then, on the basis of the received electricity supply information in the B-method, generates electricity supply information in the A-method (S305). In the present embodiment, generation of electricity supply information at step S305 indicates conversion from the B-method to the A-method achieved when the control part 20 executes the conversion application 2e.

The control part 20 transmits the electricity supply information obtained by conversion into the A-method, through the first communication part 23 to the vehicle 1 via the electricity supply line 30 (S306).

The vehicle 1 receives the electricity supply information and then executes processing on the basis of the received electricity supply information, for example, the processing of determining the electricity supply time of day. FIG. 7 illustrates an example that a tariff table and a request for this are transmitted and received as the electricity supply information. However, the present invention is not limited to this. That is, various kinds of information concerning electricity supply may be transmitted and received as the electricity supply information. As such, the electricity supply device 2 serving as a relaying device converts the communication format at the time of relaying the electricity supply information, so that communication between the communication device 6 and the vehicle 1 becomes achievable regardless of the communication method employed on the communication device 6 side.

As such, the communication system according to Embodiment 1 of the present invention is implemented.

### Embodiment 2

Embodiment 2 is a mode that in Embodiment 1, a connection device such as a gateway device is used as a relaying device. Here, in the following description, like configurations to Embodiment 1 are designated by like reference numerals to Embodiment 1. Thus, their description is omitted and to be referred to Embodiment 1.

An exemplary configuration of a communication system according to Embodiment 2 is similar to the exemplary configuration of the communication system according to Embodiment 1 described with reference to FIG. 1.

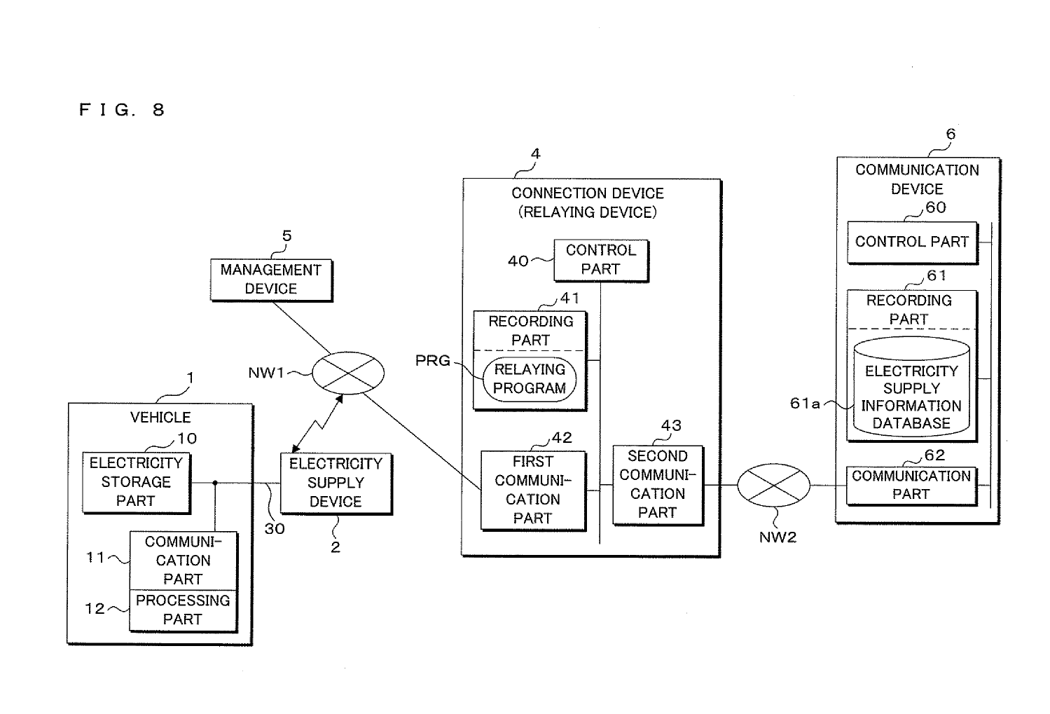

FIG. 8 is a block diagram illustrating an exemplary configuration of hardware of individual devices employed in the communication system according to Embodiment 2 of the present invention. The connection device 4 has various kinds of parts including a control part 40, a recording part 41, a first communication part 42, and a second communication part 43. The control part 40 is a processor such as a CPU controlling the entire device, and executes processing on various kinds of information recorded in the recording part 41 composed of a hard disk, a RAM, or the like. The first communication part 42 is constructed from connectors and an attached program used for connection to the internal communication network NW1 so as to achieve communication. The second communication part 43 is constructed from connectors and an attached program used for connection to the external communication network NW2 so as to achieve communication.

The recording part 41 stores various kinds of information like various kinds of programs used for the function of a gateway device and the relaying program PRG according to the present invention. When the control part 40 executes various kinds of procedures set forth in the relaying program PRG, the connection device 4 serves as a relaying device of the present invention. An exemplary configuration of the vehicle 1 and the communication device 6 is similar to the exemplary configuration in the communication system according to Embodiment 1 described with reference to FIG. 2.

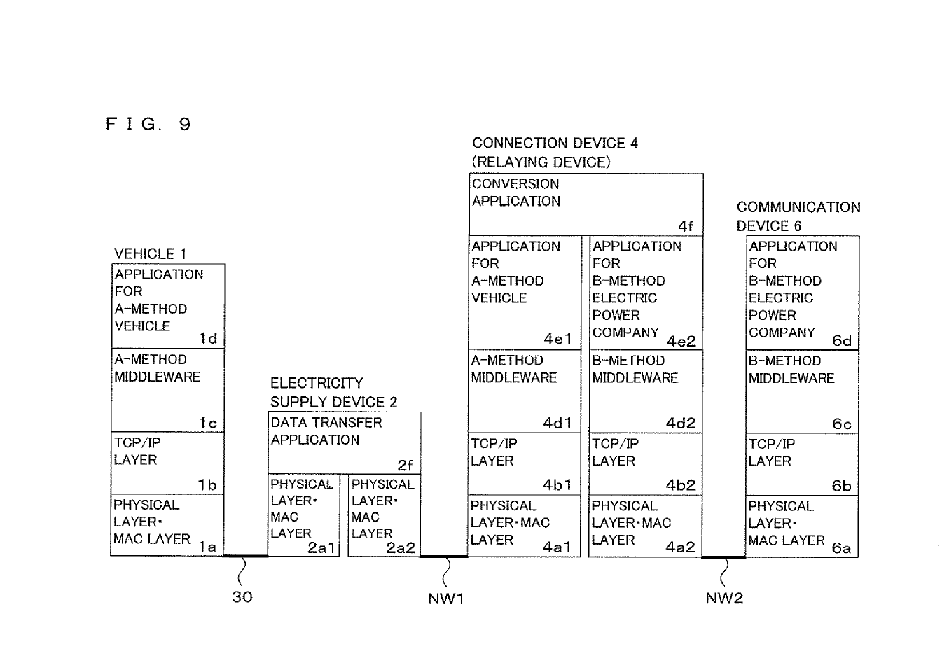

FIG. 9 is a block diagram illustrating an exemplary configuration of functions concerning communication processing of individual devices employed in the communication system according to Embodiment 2 of the present invention. The electricity supply device 2 has a physical layer•MAC layer 2a1 and a physical layer•MAC layer 2a2. Further, in the electricity supply device 2, a data transfer application 2f is incorporated as an application program used for transferring the electricity supply information.

As the functions of parts like the control part 40, the first communication part 42, and the second communication part 43, for the purpose of communication with the vehicle 1 through the electricity supply device 2, the connection device 4 has a physical layer•MAC layer 4a1, a TCP/IP layer 4b1, a hierarchy concerning middleware, and a hierarchy concerning an application program. In the example of FIG. 9, A-method middleware 4d1 is incorporated as middleware, and an application for A-method vehicle 4e1 is incorporated as an application program.

Further, for the purpose of communication with the communication device 6, the connection device 4 has a physical layer•MAC layer 4a2, a TCP/IP layer 4b2, a hierarchy concerning middleware, and a hierarchy concerning an application program. In the example of FIG. 9, B-method middleware 4d2 is incorporated as middleware, and an application for B-method electric power company 4e2 is incorporated as an application program.

Further, in the connection device 4, a conversion application 4f is incorporated that serves as an application program converting the communication format between the A-method concerning communication with the vehicle 1 and the B-method concerning communication with the communication device 6. Here, in the connection device 4, a routing application (not illustrated) also is incorporated. Then, routing processing is performed by the routing application.

An example of functional configurations of the vehicle 1 and the communication device 6 is similar to that in Embodiment 1.

In the communication system according to Embodiment 2, processing in the connection device 4 serving as a relaying device is substantially similar to that in the electricity supply device 2 according to Embodiment 1. That is, the connection device 4 receives electricity supply information in the A-method or B-method transmitted from any one of the vehicle 1 and the communication device 6, then converts the communication format of the received electricity supply information, and then transmits the electricity supply information obtained by format conversion to the other one of the vehicle 1 and the communication device 6. When the connection device 4 serving as a relaying device converts the communication format of the electricity supply information, communication between the communication device 6 and the vehicle 1 becomes achievable regardless of the communication method employed on the communication device 6 side. Here, among the processing described in Embodiment 1, the initial processing and the authentication processing may be executed by another device like the electricity supply device 2.

As such, the communication system according to Embodiment 2 of the present invention is implemented.

### Embodiment 3

Embodiment 3 is a mode that in Embodiment 1, a management device such as a HEMS adaptor is used as a relaying device. Here, in the following description, like configurations to Embodiment 1 or 2 are designated by like reference numerals to Embodiments 1 and 2. Thus, their description is omitted and to be referred to Embodiments 1 and 2.

An exemplary configuration of a communication system according to Embodiment 3 is similar to the exemplary configuration of the communication system according to Embodiment 1 described with reference to FIG. 1.

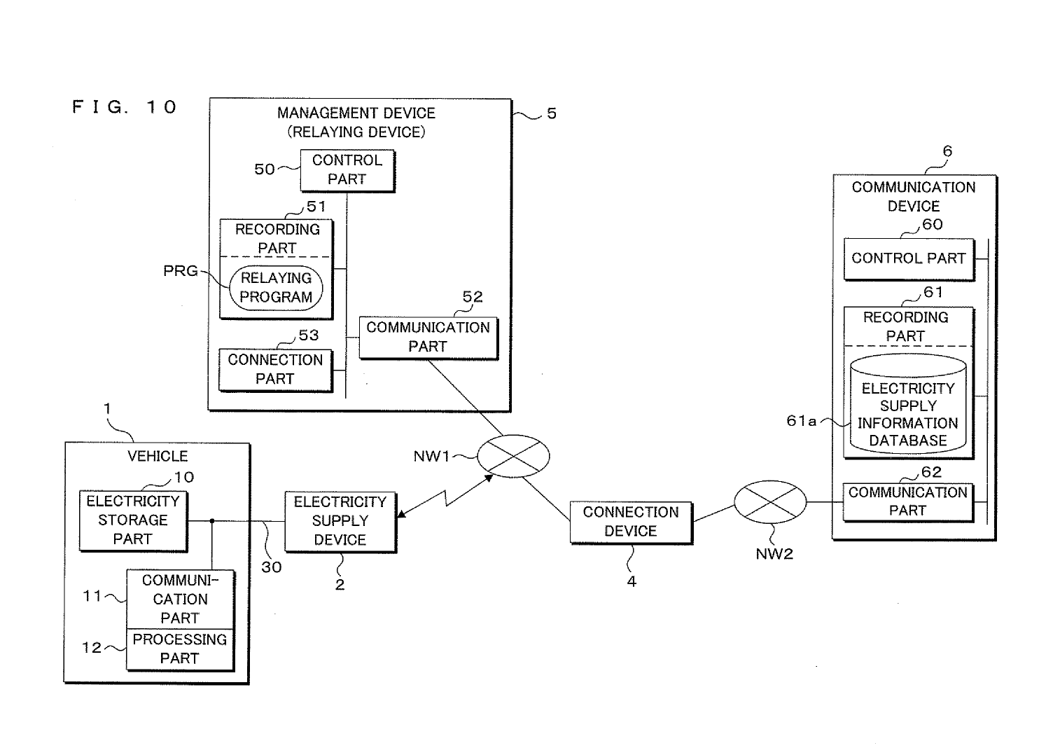

FIG. 10 is a block diagram illustrating an exemplary configuration of hardware of individual devices employed in the communication system according to Embodiment 3 of the present invention. The management device 5 has various kinds of parts including a control part 50, a recording part 51, a communication part 52, and a connection part 53. The control part 50 is a processor controlling the entire device, and executes processing on various kinds of information recorded in the recording part 51 composed of a hard disk, a RAM, or the like. The communication part 52 is constructed from connectors and an attached program used for connection to the internal communication network NW1 so as to achieve communication. The connection part 53 is constructed from connectors and an attached program used for connection to a device serving as a target of energy management.

The recording part 51 stores various kinds of information such as various kinds of programs used for implementing the function of a HEMS adaptor and a relaying program PRG of the present invention. When the control part 50 executes various kinds of procedures set forth in the relaying program PRG, the management device 5 serves as a relaying device of the present invention. An exemplary configuration of the vehicle 1 and the communication device 6 is similar to the exemplary configuration in the communication system according to Embodiment 1 described with reference to FIG. 2.

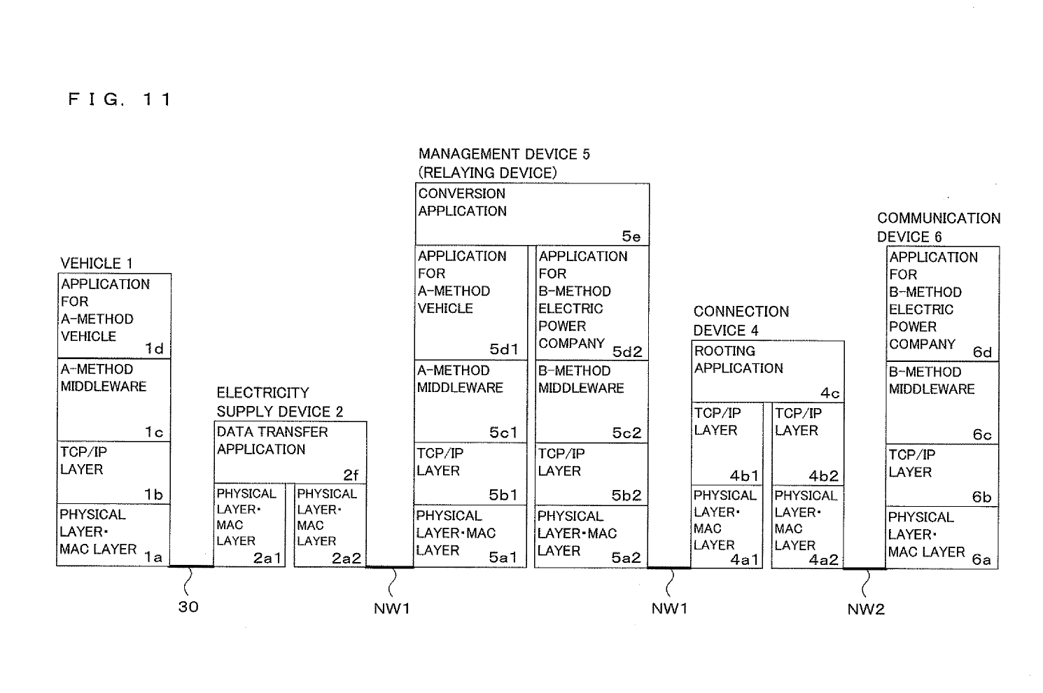

FIG. 11 is a block diagram illustrating an exemplary configuration of functions concerning communication processing of individual devices employed in the communication system according to Embodiment 3 of the present invention. As the functions of parts like the control part 50 and the communication part 52, the management device 5 has the function of communication with the vehicle 1 and the function of communication with the connection device 4. That is, for the purpose of communication with the vehicle 1 through the connection device 4 and the electricity supply device 2, the management device 5 has a physical layer•MAC layer 5a1, a TCP/IP layer 5b1, a hierarchy concerning middleware, and a hierarchy concerning an application program. In the example of FIG. 11, A-method middleware 5c1 is incorporated as middleware, and an application for A-method vehicle 5d1 is incorporated as an application program.

Further, for the purpose of communication with the communication device 6 through the connection device 4, the management device 5 has a physical layer•MAC layer 5a2, a TCP/IP layer 5b2, a hierarchy concerning middleware, and a hierarchy concerning an application program. In the example of FIG. 11, B-method middleware 5c2 is incorporated as middleware, and an application for B-method electric power company 5d2 is incorporated as an application program.

Further, in the management device 5, a conversion application 5e is incorporated that serves as an application program converting the communication format between the A-method concerning communication with the vehicle 1 and the B-method concerning communication with the communication device 6.

An example of functional configuration of the vehicle 1, the connection device 4, and the communication device 6 is similar to that in Embodiment 1, and an example of functional configuration of the electricity supply device 2 is similar to that in Embodiment 2.

In the communication system according to Embodiment 3, processing in the management device 5 serving as a relaying device is substantially similar to that in the electricity supply device 2 according to Embodiment 1. That is, the management device 5 receives electricity supply information in the A-method or B-method transmitted from any one of the vehicle 1 and the communication device 6, then converts the communication format of the received electricity supply information, and then transmits the electricity supply information obtained by format conversion to the other one of the vehicle 1 and the communication device 6. When the management device 5 serving as a relaying device converts the communication format of the electricity supply information, communication between the communication device 6 and the vehicle 1 becomes achievable regardless of the communication method employed on the communication device 6 side. Here, among the processing described in Embodiment 1, the initial processing and the authentication processing may be executed by another device like the electricity supply device 2.

As such, the communication system according to Embodiment 3 of the present invention is implemented.

### Embodiment 4

Embodiment 4 is a mode that in Embodiment 1, communication with a communication device is achieved by using a measuring device such as a smart meter measuring the amount of electricity such as electric energy supplied from the electric power company. Here, in the following description, like configurations to Embodiment 1 are designated by like reference numerals to Embodiment 1. Thus, their description is omitted and to be referred to Embodiment 1.

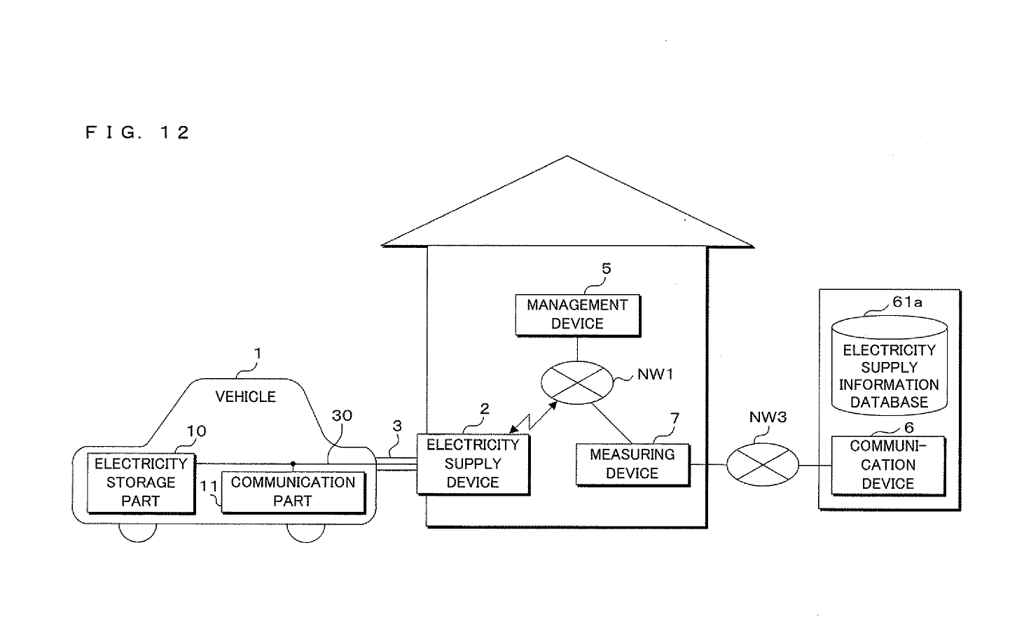

FIG. 12 is an explanation diagram conceptually illustrating an exemplary configuration of a communication system according to Embodiment 4 of the present invention. The internal communication network NW1 is connected to a measuring device 7 such as a smart meter measuring the amount of electricity concerning electricity supply. The measuring device 7 is connected to a dedicated communication network NW3 managed by a business entity such as an electric power company, and hence is allowed to perform communication with the communication device 6 through the dedicated communication network NW3. The other points in the configuration are similar to those of Embodiment 1 described with reference to FIG. 1.

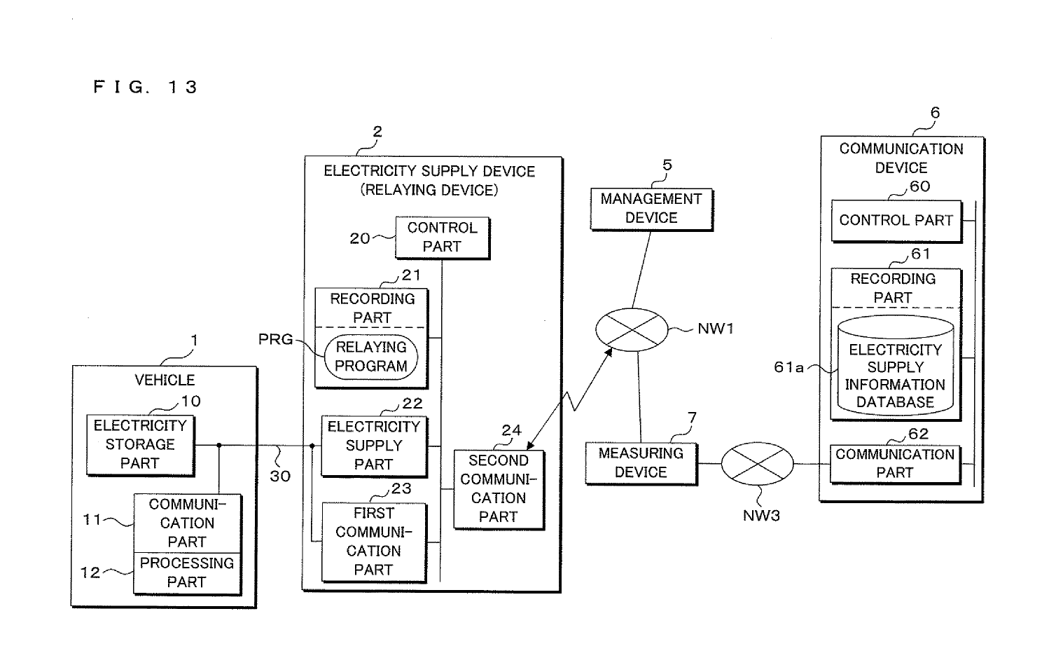

FIG. 13 is a block diagram illustrating an exemplary configuration of hardware of individual devices employed in the communication system according to Embodiment 4 of the present invention. The communication device 6 has various kinds of parts including a control part 60, a recording part 61, and a communication part 62. Then, the communication device 6 is connected through the communication part 62 to the dedicated communication network NW3 and allowed to perform communication with the measuring device 7.

In Embodiment 4, the electricity supply device 2 serves as a relaying device of the present invention. The other points in the configuration of the devices are similar to those of Embodiment 1.

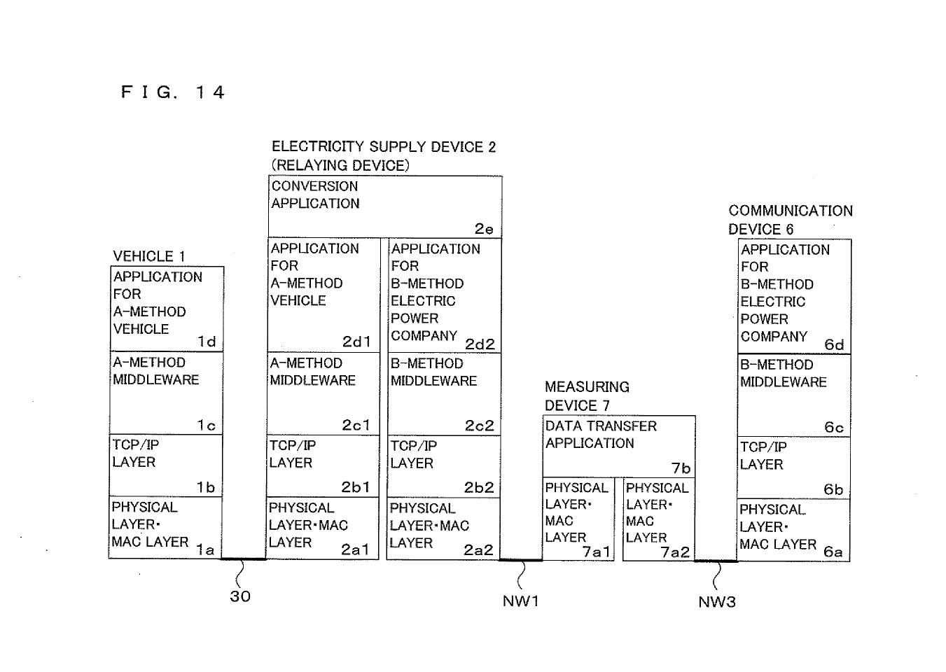

FIG. 14 is a block diagram illustrating an exemplary configuration of functions concerning communication processing of individual devices employed in the communication system according to Embodiment 4 of the present invention. The measuring device 7 has the function of communication with the electricity supply device 2 and the function of communication with the communication device 6. That is, the measuring device 7 has a physical layer•MAC layer 7a1 for the purpose of communication with the electricity supply device 2, and further has a physical layer•MAC layer 7a2 for the purpose of communication with the communication device 6. Further, in the measuring device 7 a data transfer application 7b is incorporated as an application program used for transferring the electricity supply information.

An example of functional configurations of the vehicle 1, the electricity supply device 2, and the communication device 6 is similar to that in Embodiment 1.

In the communication system according to Embodiment 4, the processing performed by the electricity supply device 2 serving as a relaying device is substantially similar to that in Embodiment 1. That is, the electricity supply device 2 receives electricity supply information in the A-method or B-method transmitted from any one of the vehicle 1 and the communication device 6, then converts the communication format of the received electricity supply information, and then transmits the electricity supply information obtained by format conversion to the other one of the vehicle 1 and the communication device 6. When the electricity supply device 2 serving as a relaying device converts the communication format of the electricity supply information, communication between the communication device 6 and the vehicle 1 becomes achievable regardless of the communication method employed on the communication device 6 side.

As such, the communication system according to Embodiment 4 of the present invention is implemented.

### Embodiment 5

Embodiment 5 is a mode that in Embodiment 4, a measuring device such as a smart meter is used as a relaying device. Here, in the following description, like configurations to any one of Embodiments 1 to 4 are designated by like reference numerals to Embodiments 1 to 4. Thus, their description is omitted and to be referred to Embodiments 1 to 4.

An exemplary configuration of a communication system according to Embodiment 5 is similar to the exemplary configuration of the communication system according to Embodiment 4 described with reference to FIG. 12.

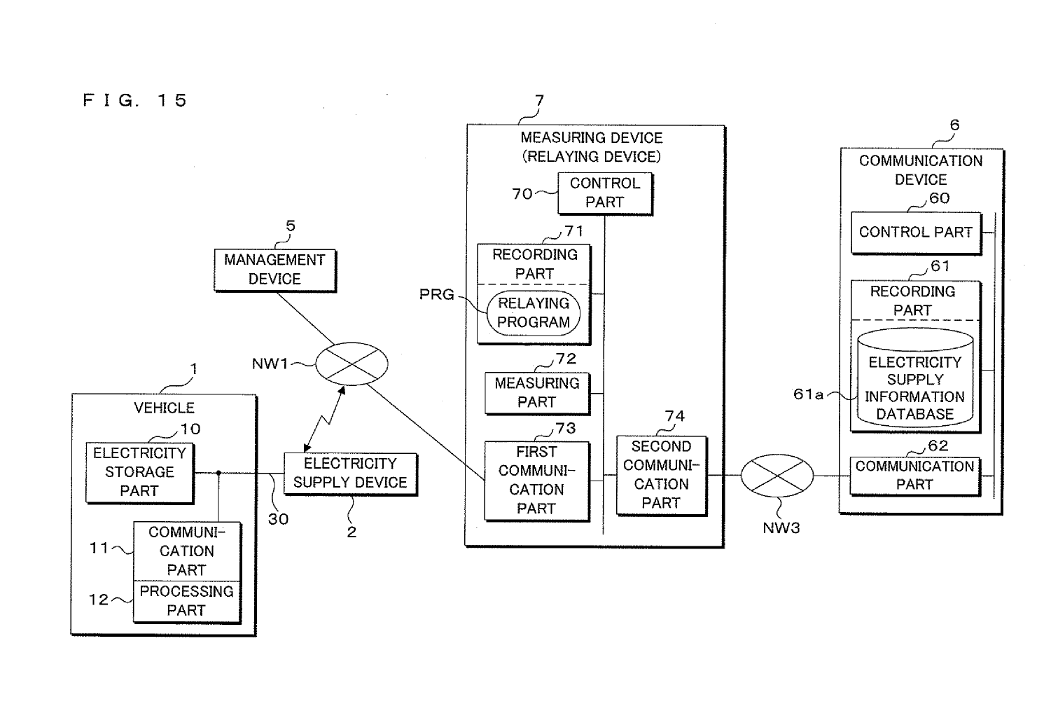

FIG. 15 is a block diagram illustrating an exemplary configuration of hardware of individual devices employed in the communication system according to Embodiment 5 of the present invention. The measuring device 7 has various kinds of parts including a control part 70, a recording part 71, a measuring part 72, a first communication part 73, and a second communication part 74. The control part 70 is a processor such as a CPU controlling the entire device, and executes processing on various kinds of information recorded in the recording part 71 composed of a hard disk, a RAM, or the like. The measuring part 72 is a device measuring the amount of electricity such as electric energy supplied from the electric power company. The first communication part 73 is constructed from connectors and an attached program used for connection to the internal communication network NW1 so as to achieve communication. The second communication part 74 is constructed from connectors and an attached program used for connection to the dedicated communication network NW3 so as to achieve communication.

In the measuring device 7, under the control of the control part 70, the measuring part 72 measures the amount of electricity. Then, amount-of-electricity information indicating the measured amount of electricity is transmitted through the second communication part 74 to the communication device 6 via the dedicated communication network NW3. Further, the recording part 71 stores various kinds of information like various kinds of programs used for the function of a smart meter and the relaying program PRG according to the present invention. When the control part 70 executes various kinds of procedures set forth in the relaying program PRG, the measuring device 7 serves as a relaying device of the present invention. An exemplary configuration of the vehicle 1 and the communication device 6 is similar to the exemplary configuration in the communication system according to Embodiment 4 described with reference to FIG. 13.

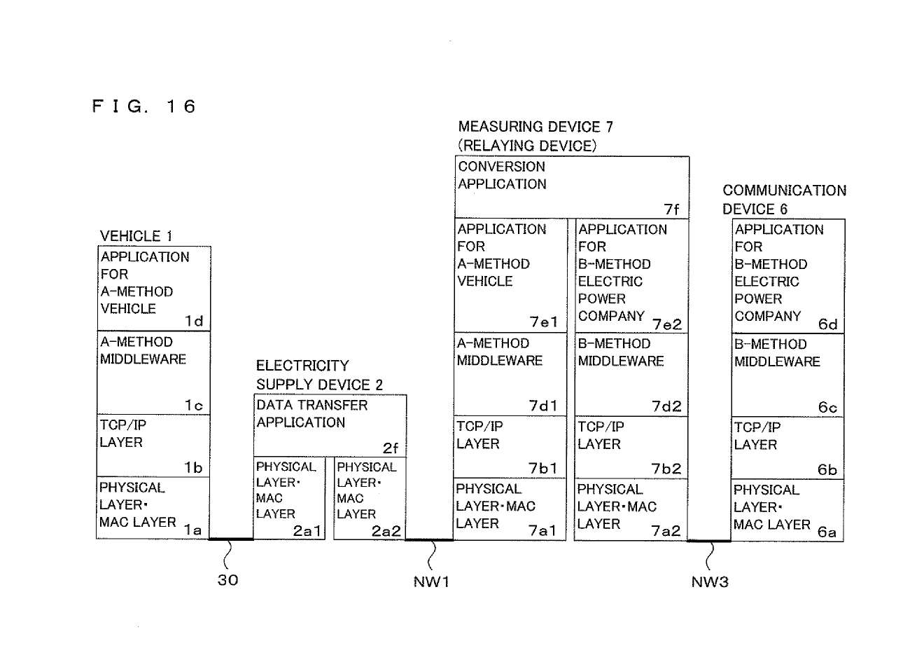

FIG. 16 is a block diagram illustrating an exemplary configuration of functions concerning communication processing of individual devices employed in the communication system according to Embodiment 5 of the present invention. As the functions of parts like the control part 70, the first communication part 73, and the second communication part 74, for the purpose of communication with the vehicle 1 through the electricity supply device 2, the measuring device 7 has a physical layer•MAC layer 7a1, a TCP/IP layer 7b1, a hierarchy concerning middleware, and a hierarchy concerning an application program. In the example of FIG. 16, A-method middleware 7d1 is incorporated as middleware, and an application for A-method vehicle 7e1 is incorporated as an application program.

Further, for the purpose of communication with the communication device 6, the measuring device 7 has a physical layer•MAC layer 7a2, a TCP/IP layer 7b2, a hierarchy concerning middleware, and a hierarchy concerning an application program. In the example of FIG. 16, B-method middleware 7d2 is incorporated as middleware, and an application for B-method electric power company 7e2 is incorporated as an application program.

Further, in the measuring device 7, a conversion application 7f is incorporated that serves as an application program converting the communication format between the A-method concerning communication with the vehicle 1 and the B-method concerning communication with the communication device 6.

An example of functional configurations of the vehicle 1, the electricity supply device 2, and the communication device 6 is similar to that in Embodiment 2.

In the communication system according to Embodiment 5, processing in the measuring device 7 serving as a relaying device is substantially similar to that in the electricity supply device 2 according to Embodiment 1. That is, the measuring device 7 receives electricity supply information in the A-method or B-method transmitted from any one of the vehicle 1 and the communication device 6, then converts the communication format of the received electricity supply information, and then transmits the electricity supply information obtained by format conversion to the other one of the vehicle 1 and the communication device 6. When the measuring device 7 serving as a relaying device converts the communication format of the electricity supply information, communication between the communication device 6 and the vehicle 1 becomes achievable regardless of the communication method employed on the communication device 6 side. Here, among the processing described in Embodiment 1, the initial processing and the authentication processing may be executed by another device like the electricity supply device 2.

As such, the communication system according to Embodiment 5 of the present invention is implemented.

### Embodiment 6

Embodiment 6 is a mode that in Embodiment 4, a management device such as a HEMS adaptor is used as a relaying device. Here, in the following description, like configurations to any one of Embodiments 1 to 5 are designated by like reference numerals to Embodiments 1 to 5. Thus, their description is omitted and to be referred to Embodiments 1 to 5.

An exemplary configuration of a communication system according to Embodiment 6 is similar to the exemplary configuration of the communication system according to Embodiment 4 described with reference to FIG. 12.

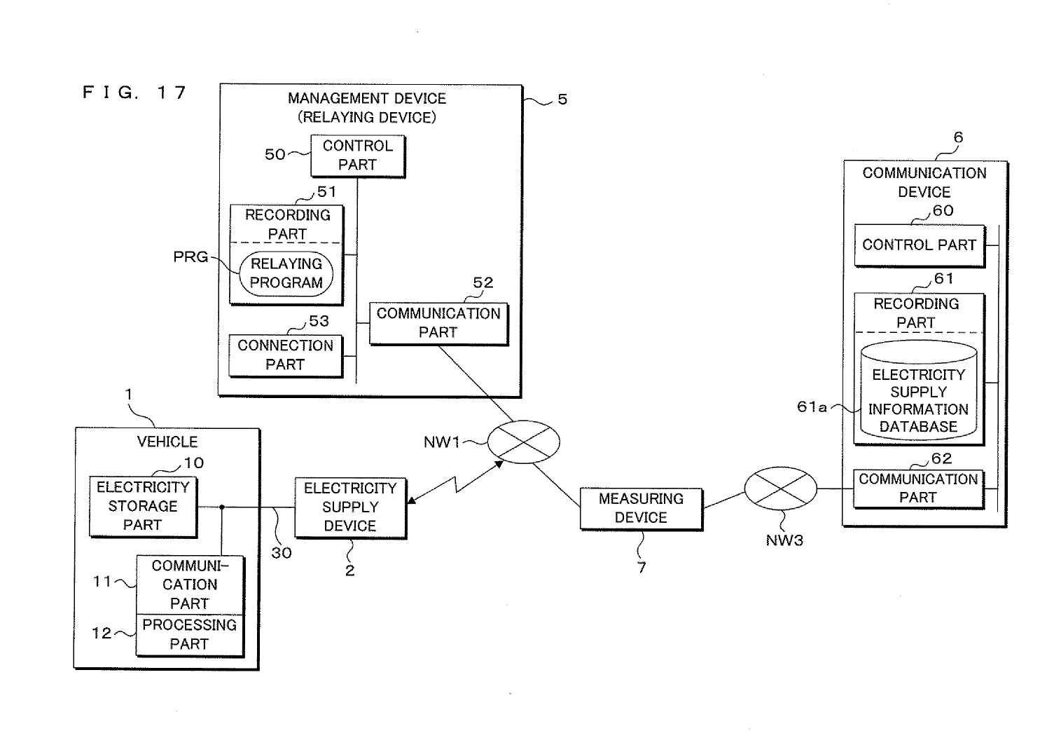

FIG. 17 is a block diagram illustrating an exemplary configuration of hardware of individual devices employed in the communication system according to Embodiment 6 of the present invention. An exemplary configuration of the vehicle 1, the electricity supply device 2, and the management device 5 is similar to that in Embodiment 3. Further, an exemplary configuration of the communication device 6, the measuring device 7, and the communication network between them is similar to that in Embodiment 4.

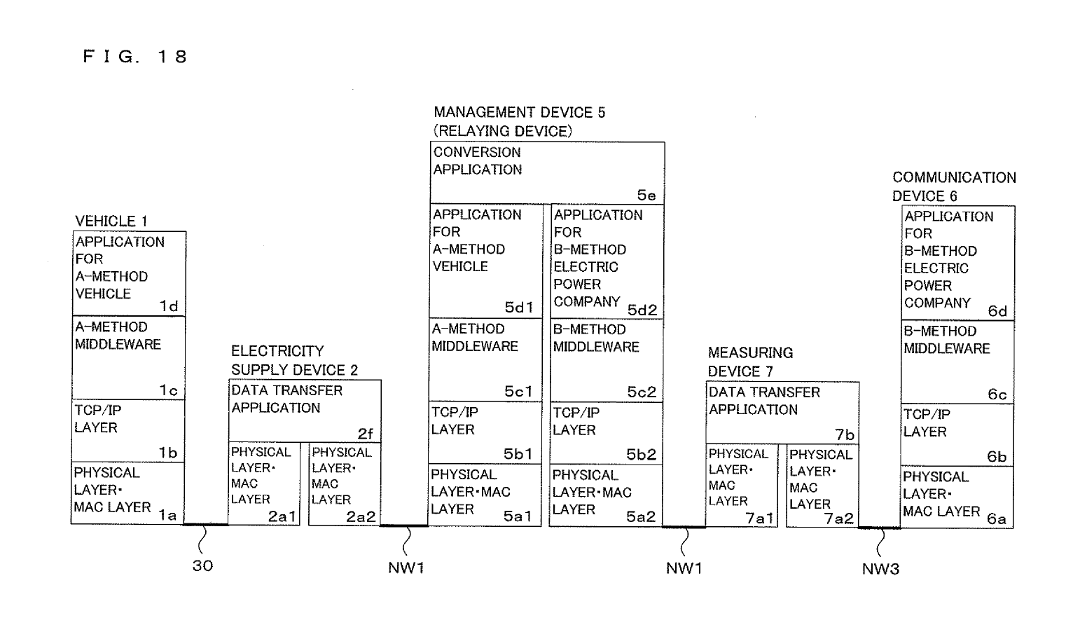

FIG. 18 is a block diagram illustrating an exemplary configuration of functions concerning communication processing of individual devices employed in the communication system according to Embodiment 6 of the present invention. An example of functional configurations of the vehicle 1, the electricity supply device 2, and the management device 5 is similar to that in Embodiment 3. Further, an example of functional configuration of the communication device 6 and the measuring device 7 is similar to that in Embodiment 4.

In the communication system according to Embodiment 6, processing in the management device 5 serving as a relaying device is substantially similar to that in the electricity supply device 2 according to Embodiment 1. That is, the management device 5 receives electricity supply information in the A-method or B-method transmitted from any one of the vehicle 1 and the communication device 6, then converts the communication format of the received electricity supply information, and then transmits the electricity supply information obtained by format conversion to the other one of the vehicle 1 and the communication device 6. When the management device 5 serving as a relaying device converts the communication format of the electricity supply information, communication between the communication device 6 and the vehicle 1 becomes achievable regardless of the communication method employed on the communication device 6 side. Here, among the processing described in Embodiment 1, the initial processing and the authentication processing may be executed by another device like the electricity supply device 2.

As such, the communication system according to Embodiment 6 of the present invention is implemented.

Embodiments 1 to 6 given above have disclosed merely a part of an infinite number of embodiments of the present invention. Various kinds of system configuration, hardware configuration, information processing by software, and the target of processing may be designed appropriately depending on the purpose, the application, and the like.

For example, Embodiments 1 to 6 given above have been described for a mode of a communication system employing power line communication in which communication is performed through an electricity supply line. However, the present invention is not limited to these and may be applied to various kinds of modes like a mode of inband communication in which electricity supply information is transmitted through a control line used for transmitting a control signal such as a control pilot signal (CPLT signal) necessary for electricity supply control.

Further, the target of conversion of the communication method is not limited to information to be transmitted and received, and may be various kinds of items like the communication protocol.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. A communication system comprising
a relaying device relaying communication between a vehicle, the vehicle including an electricity storage part and with a communication part, and a communication device performing communication of electricity supply information concerning electricity supply to the electricity storage part,
the relaying device including:
a first communication part performing communication of electricity supply information to and from the vehicle by a first method;
a second communication part performing communication of electricity supply information to and from the communication device by a second method different from the first method; and
a generating part, on the basis of the electricity supply information received by any one of the first method and the second method, generating electricity supply information to be transmitted by the other method.

2. The communication system according to claim 1,
wherein the vehicle and the relaying device are allowed to be connected through an electricity supply line used for electricity supply, and
wherein the communication of electricity supply information by the first method is communication through the electricity supply line.

3. The communication system according to claim 1,
wherein the communication device includes:
an authentication part performing authentication of the relaying device; and
a first transmitting part transmitting condition information that indicates a plurality of conditions concerning electricity supply, to the relaying device whose authentication has been succeeded, and
wherein the relaying device further includes
a second transmitting part transmitting, to the communication device, selection information that indicates one condition selected from the plurality of conditions indicated in the received condition information.

4. A communication method employing a relaying device relaying communication between a vehicle provided with an electricity storage part and with a communication part and a communication device performing communication of electricity supply information concerning electricity supply to the electricity storage part,
wherein the relaying device performs steps of:
receiving electricity supply information transmitted from any one of the vehicle and the communication device by a first method;
on the basis of the received electricity supply information, generating electricity supply information to be transmitted by a second method different from the first method; and
transmitting the electricity supply information to the other one of the vehicle and the communication device by the second method.

5. A relaying device relaying communication between a vehicle provided with an electricity storage part and with a communication part and a communication device performing communication of electricity supply information concerning electricity supply to the electricity storage part, comprising:
a first communication part performing communication of electricity supply information to and from the vehicle by a first method;
a second communication part performing communication of electricity supply information to and from the communication device by a second method different from the first method; and
a generating part, on the basis of the electricity supply information received by any one of the first method and the second method, generating electricity supply information to be transmitted by the other method.

6. The relaying device according to claim 5, further comprising
a supply part supplying electricity through an electricity supply line connectable to the vehicle,
wherein the first communication part performs communication of electricity supply information through the electricity supply line by the first method.

7. The relaying device according to claim 5,
wherein connection to an electricity supply device is achievable, the electricity supply device being connectable to the vehicle through an electricity supply line used for electricity supply and performing communication of electricity supply information to and from the vehicle through the electricity supply line, and
wherein the first communication part performs communication with the vehicle through the electricity supply device.

8. The relaying device according to claim 5, further comprising:
a measuring part measuring the amount of electricity concerning electricity supply; and
an electricity amount transmitting part transmitting to the communication device the measured amount of electricity.

9. A non-transitory computer-readable recording medium in which a computer program for causing a computer to execute a procedure concerning relaying is recorded, wherein the computer relays communication between a vehicle provided with an electricity storage part and a communication device performing communication of electricity supply information concerning electricity supply to the electricity storage part, the procedure comprising steps of:
generating, in response to electricity supply information transmitted from any one of the vehicle and the communication device by a first method, on the basis of the electricity supply information, electricity supply information to be transmitted by a second method different from the first method; and
transmitting the generated electricity supply information to the other one of the vehicle and the communication device by the second method.
